(19) United States
(12) Patent Application Publication
(10) Pub. No.: US 2011/0238467 A1
(43) Pub. Date: Sep. 29, 2011

(54) Caddie Apparatus with Display Capabilities

(75) Inventors: Dave Duley, Alpharetta, GA (US); John Thomas McManus, Alpharetta, GA (US)

(73) Assignee: COMMCADDY NETWORK, LLC, Alpharetta, GA (US)

(21) Appl. No.: 13/029,192

(22) Filed: Feb. 17, 2011

Related U.S. Application Data
(60) Provisional application No. 61/318,369, filed on Mar. 28, 2010.
(60) Provisional application No. 61/383,476, filed on Sep. 16, 2010.

(51) Int. Cl. G06Q 30/00

(52) U.S. Cl. 705/14.4

(57) ABSTRACT

A system is disclosed for conveying information to patrons in an establishment. The system comprises one or more caddies implemented in one or more zones within the establishment, wherein each of the one or more caddies comprises a display unit and one or more compartments for storing items for use by the patrons. The system further comprises a content server located in the establishment, the content server configured to transmit information to each of the one or more caddies to be displayed on the display units for the patrons to view, the content server being communicatively coupled to the one or more caddies via a local area network (LAN) implemented within the establishment, wherein the content server transmits information to each of the one or more caddies according to the one or more zones in which the one or more caddies are implemented.

### CROSS-REFERENCE TO RELATED APPLICATION

This application claims priority to, and the benefit of, U.S. Provisional patent application entitled, “Media Bar Caddie,” having Ser. No. 61/318,369, filed on Mar. 29, 2010, and to U.S. Provisional patent application entitled, “Caddie with Display,” having Ser. No. 61/383,476, filed on Sep. 16, 2010, both of which are incorporated by reference in their entireties.

### TECHNICAL FIELD

The present disclosure generally relates to a caddie apparatus, and more particularly to caddie of the type used in restaurants and bars or lounges.

### BACKGROUND

Restaurants, bars, and other establishments frequently rely on paper advertisements provided on dining tables and counters for patrons to view. One perceived shortcoming, however, is that such advertisements are static in nature and display only a very limited amount of information. Furthermore, paper advertisements can be relatively expensive to print. A need therefore exists for a more efficient means of conveying information to patrons in an establishment.

### SUMMARY

Briefly described, one embodiment, among others, is a system for conveying information to patrons in an establishment. The system comprises one or more caddies implemented in one or more zones within the establishment, wherein each of the one or more caddies comprises a display unit and one or more compartments for storing items for use by the patrons. The system further comprises a content server located in the establishment, the content server configured to transmit information to each of the one or more caddies to be displayed on the display units for the patrons to view, the content server being communicatively coupled to the one or more caddies via a local area network (LAN) implemented within the establishment, wherein the content server transmits information to each of the one or more caddies according to the one or more zones in which the one or more caddies are implemented.

Another embodiment is a system that comprises one or more caddies, wherein each of the one or more caddies comprises a display unit. The system further comprises a content server configured to transmit media content to each of the one or more caddies to be displayed on the display units, wherein the content server is communicatively coupled to the one or more caddies via a network.

Another embodiment is a caddie that comprises a display unit configured to display media content, a content manager for receiving the media content, and one or more compartments for storing items.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a perspective view of a caddie constructed in accordance with one embodiment.

FIG. 2 is an exploded perspective view of the caddie in FIG. 1.

FIG. 3 is a top view of an embodiment of the caddie in FIG. 1.

FIG. 4 illustrates the caddie in operation.

FIGS. 5-7 depict a block diagram of a networked environment in which embodiments of the caddie shown in FIG. 1 may be implemented.

FIG. 8 shows various components of the caddie depicted in FIGS. 5-7.

FIG. 9 illustrates an embodiment of the caddie system whereby the content server conveys different media content to different caddies.

### DETAILED DESCRIPTION

Having summarized various aspects of the present disclosure, reference will now be made in detail to the description of the disclosure as illustrated in the drawings. While the disclosure will be described in connection with these drawings, there is no intent to limit it to the embodiment or embodiments disclosed herein. On the contrary, the intent is to cover all alternatives, modifications and equivalents included within the spirit and scope of the disclosure as defined by the appended claims.

Caddies or carriers are frequently used in restaurants or bars for holding utensils, salt and pepper shakers, napkins, straws, coasters, condiments, or other items. Various embodiments are described that are broadly directed to caddies or carriers having an integrated electronic display for actively displaying information to patrons. The use of active displays allows establishments to reduce or eliminate paper marketing items and the corresponding expense for producing such items. Significantly, the use of displays with actively changing content allows a much larger number of ads or other materials to be presented to patrons. While the content display to patrons may comprise audio/video, the content display may also comprise static content such as non-moving text in order to avoid being a distraction to patrons. The caddies (e.g., restaurant caddies, bar caddies, etc.) disclosed herein allow establishments to convey information in a simple and efficient means in a centralized manner.

In addition to marketing materials, such content as menu items and specials can also be displayed. In accordance with exemplary embodiments, the display is a flat-panel display comprising, for example, a liquid crystal display (LCD) that is sized appropriately for the particular caddie/carrier. It should be emphasized that while various embodiments are described herein in the context of a restaurant or bar, the caddie apparatus may be implemented in any type of establishment (e.g., coffee shops, stores) where a need exists for communicating information to patrons or customers. Modifications may be made to the embodiments described herein without departing from the principles of the present disclosure. All such modifications and variations are intended to be included herein within the scope of this disclosure and protected by the following claims.

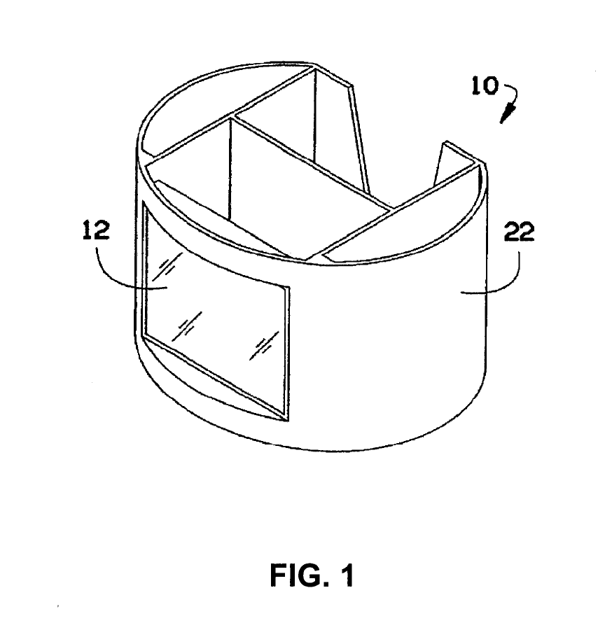

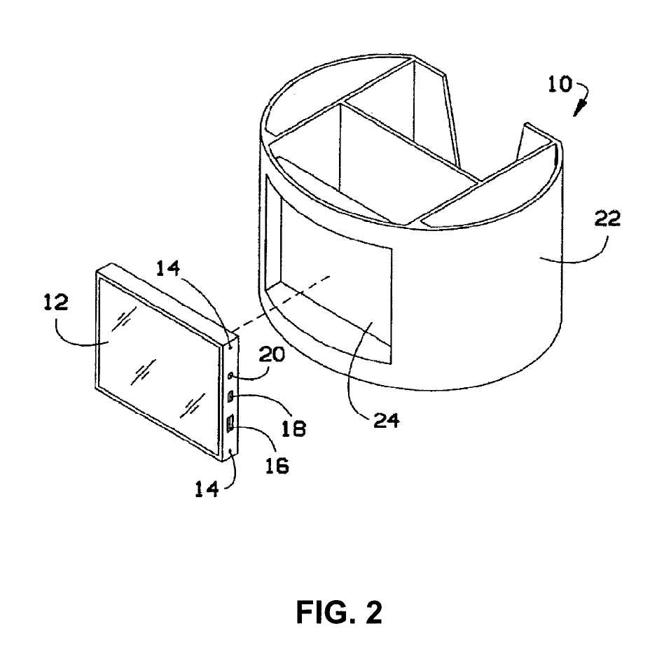

Reference is made to FIG. 1, which is a perspective view of a caddie constructed in accordance with one embodiment. The caddie 10 includes a display unit 12, which may comprise, for example, an LCD. The body 22 of the caddie 10 may comprise a casing/mold, which can be of any of a number of shapes, sizes, or storage configurations. The body 22 houses one or more display units 12 of a variety of shapes. With reference to FIG. 2, the display 12 in the caddie 10 may be constructed to include a series of connection holes 14 for mounting the display 12 into the body 22 of the caddie 10 in the cavity 24 shown. As will be discussed in more detail later, the caddie 10 may include various interfaces, including, but not limited to, a USB port 16 and a mini USB port 18. The display 12 further comprises an audio port 20.

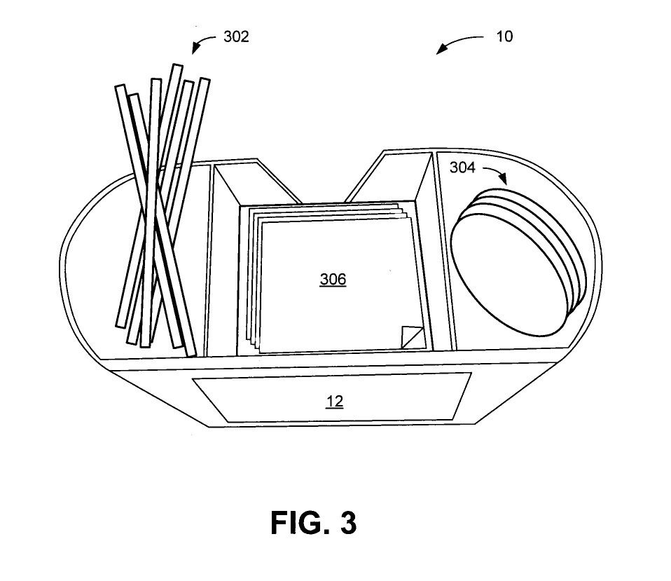

As shown in FIGS. 2 and 3, the caddie 10 includes a number of compartments formed by wall members for storing such items as straws 302, coasters 304, and napkins 306. Other items may include utensils, salt/pepper shakers, condiments, etc. for patrons to use. The body of the caddie 10 is defined by the housing 22, which may be constructed of plastic (e.g., via injection molding) or other suitable material. As described earlier, the display unit 12 is coupled to the housing 22 such that the compartments in the caddie 10 are in close proximity to the display unit 12. The display unit 12 is preferably a flat-panel display, such as an LCD, in order to minimize the amount of space required for the display unit 12. The caddie 10 is configured to actively display a variety of content including advertisements (generated, for example, by the establishment or by a third party), menu items, restaurant specials, news, weather, sports, etc.

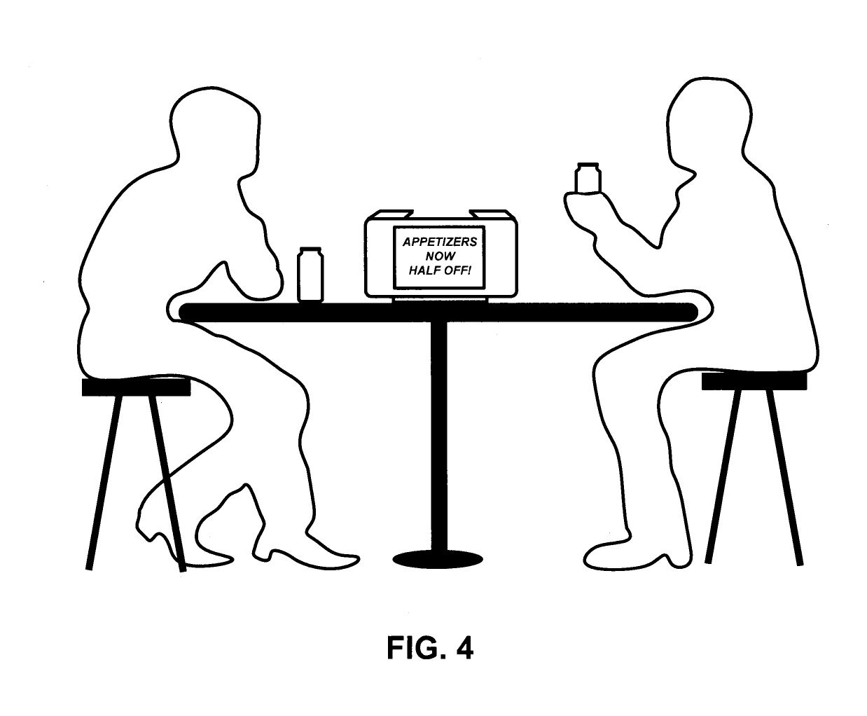

Reference is made to FIG. 4, which illustrates the caddie in use in a bar or restaurant setting. In the case of advertisements, the use of an active, content-controllable display allows the restaurant or bar to exhibit a greater variety of advertisements to patrons than traditional print media at a fraction of the cost. Restaurants and bar frequently provide a paper advertisement such as a tri-fold ad on the table top. Such advertisements, however, are static, and consequently only display a very limited amount of information to a given patron. Furthermore, once the advertisements are no longer relevant, the paper advertisements are discarded. Paper advertisements are also relatively expensive to produce. In contrast, an active, electronic display is capable of cycling through a variety of different ads or other content during the course of a single meal. Furthermore, the restaurant/bar can control the timing of messages/ads shown to patrons. For example, in the illustration depicted in FIG. 4, the restaurant configures the caddie to notify patrons that appetizers are currently half off in an effort to generate more sales. The restaurant/bar may later configure the caddie to display a different message (e.g., the dinner special for that day). Note that the caddie can also be configured to display other general information such as weather information, news, game scores, and so on.

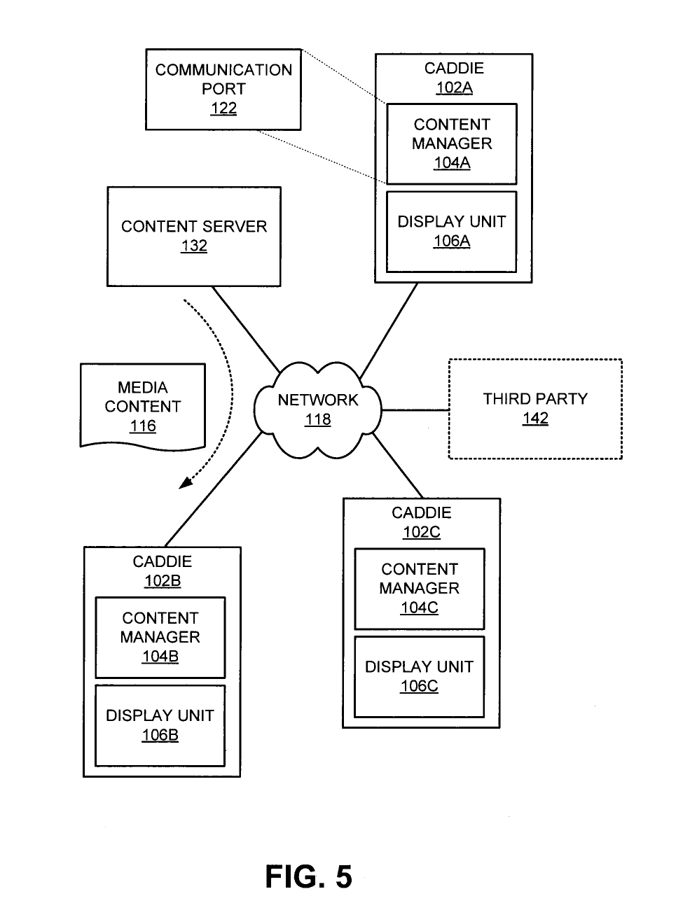

Reference is made to FIG. 5, which depicts a block diagram of a networked environment in which embodiments of the caddie 102A-C may be implemented. The network generally includes a plurality of caddies 102A-C, where each caddie 102A-C comprises a content manager 104A-C and a display unit 106A-B. The content manager 104A-C is configured to interface with a content server 132 controlled by the restaurant. The content server 132 provides centralized control over the caddies 102A-C in the network. Each of the caddies 104A-C are communicatively coupled to the content server 132 via a network 118. The content manager 104A in each of the caddies 102A-C includes a communication port 122, which may comprise a USB port, mini-USB port, Ethernet port, network interface controller (NIC), and other interlaces for transmitting and receiving data. Each caddie 102A-C receives media content 116 from the content server 132 via the communication port 122. The media content 116 comprises such audio/video content as advertisements, announcements, news, game scores, and so on. The communication port 122 may also be connected, for example, to a general purpose computer to receive data uploads or program updates. In some embodiments, the communication portion (e.g., Ethernet port) may be coupled to a computer network, where content updates are regularly provided or changed.

As shown in FIG. 5, the networked environment may further comprise a third party 142 coupled to the network 118. In some cases, a supplier/vendor for the restaurant (for example, a beverage supplier) may wish to send the restaurant specific ads for patrons to view. As an example, consider the scenario where a brewery provides a particular brand of beer to the restaurant. The brewery may wish for patrons to view ads on other beers offered by that brewery. The brewery (i.e, the third party 142 in FIG. 5) provides the media content 116 to the content server 132 (i.e., the restaurant). The content server 132 then controls the transmission of the media content 116 (advertisements) to the caddies 102A-C for the patrons to view. In this regard, the restaurant is able to control transmission of all the content viewed by its patrons via the content server 132. Note, however, that in accordance with alternative embodiments, the content server 132 may give third parties 142 permission to convey media content 116 directly to the caddies 102A-C.

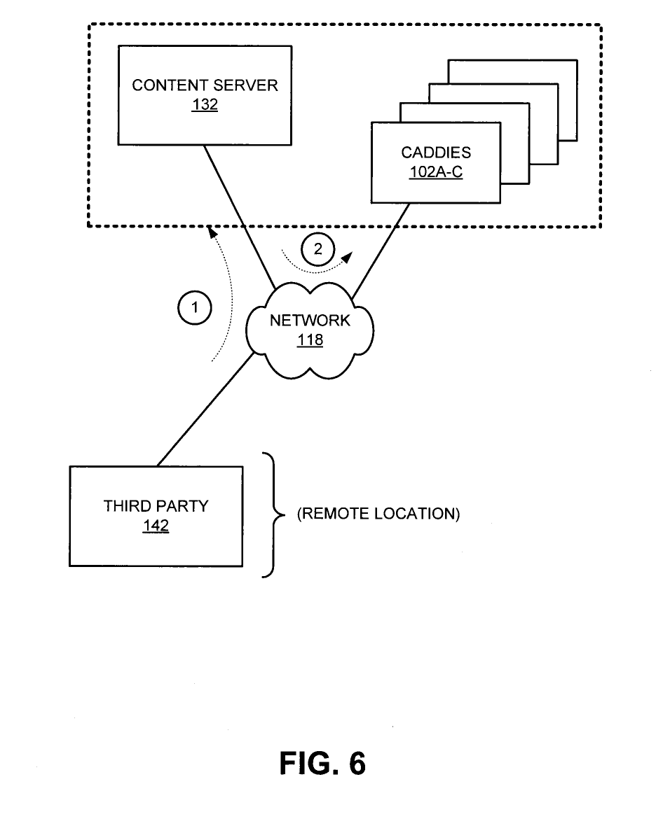

FIG. 6 illustrates a networked environment in which the third party 142 is at a remote location with respect to the content server 132, which is typically incorporated in the restaurant or establishment. The third party 142 communicates with the content server 132, and in some embodiments, directly with the caddies 102A-C. Note, however, that the system may be configured such that the content server 132 operates as a gateway through which content from the third party 142 must pass. This allows the content server 132 (i.e., the establishment) to maintain full control over the content delivered to the caddies 102.

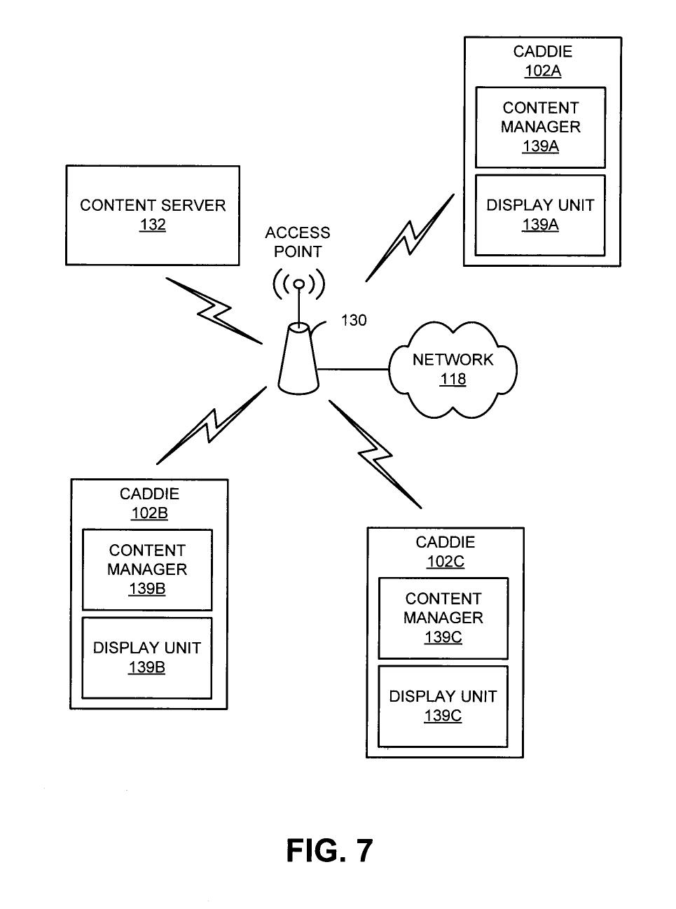

FIG. 7 illustrates a networked environment in which the caddies 102A-C communicate with the content server 132 via a wireless network. As shown, the caddies 102A-C and the content server 132 may be wirelessly connected via an access point 130. Although not specifically illustrated, a wired port may be provided in addition to the wireless transceiver. A wireless transceiver integrated in the communication port 122 within each caddie 102A-C may be configured to communicate with the content server 132. In one embodiment, the wireless transceiver may communicate with other devices via an IEEE 802.11 network, a cellular network, or via other communication protocols. Media content 116 may be provided to the caddie 102A-C for display via the wireless transceiver with the data being stored in memory.

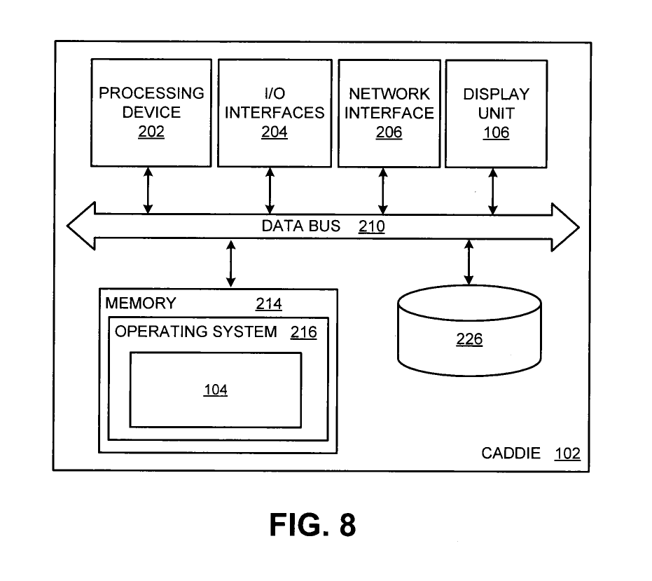

FIG. 8 shows various components of the caddie depicted in FIGS. 5-7. The caddie 102 may be embodied in any one of a wide variety of wired and/or wireless computing devices, multiprocessor computing device, and so forth incorporated into the body of the caddie 10 shown in FIGS. 1 and 2. As shown in FIG. 8, each caddie 102 comprises memory 214, a processing device 202, a number of input/output interfaces 204, a display unit 106, and mass storage 226, wherein each of these devices are connected across a local data bus 210. The mass storage 226 may be configured to store such data as the content media 116 depicted in FIG. 5. The processing device 202 may include any custom made or commercially available processor, a central processing unit (CPU) or an auxiliary processor among several processors associated with the caddie 102, a semiconductor based microprocessor (in the form of a microchip), a macroprocessor, one or more application specific integrated circuits (ASICs), a plurality of suitably configured digital logic gates, and other well known electrical configurations comprising discrete elements both individually and in various combinations to coordinate the overall operation of the computing system.

The memory 214 can include any one of a combination of volatile memory elements (e.g., random-access memory (RAM, such as DRAM, and SRAM, etc.)) and nonvolatile memory elements (e.g., ROM, hard drive, tape, CDROM, etc.). The memory 214 typically comprises a native operating system 216, one or more native applications, emulation systems, or emulated applications for any of a variety of operating systems and/or emulated hardware platforms, emulated operating systems, etc. For example, the applications may include application specific software which may comprise some or all the components (e.g., the content manager 104) of the caddie 102 depicted in FIG. 1. In accordance with such embodiments, the components are stored in memory 214 and executed by the processing device 202. One of ordinary skill in the art will appreciate that the memory 214 can, and typically will, comprise other components which have been omitted for purposes of brevity.

Input/output interfaces 204 provide any number of interfaces for the input and output of data. For example, where the caddie 102 comprises a personal computer, these components may interface with one or more user input devices 204, which may comprise a keyboard or a mouse. Note that for various embodiments, however, the caddie 10 may be constructed without an input/output interface so that the patrons cannot change the content being shown on the display unit 106. This allows the content server 132 full control over what media content 116 is displayed on the caddies 102. In alternative embodiments, the user can scroll through media content 116 via a touch screen.

The display unit 106 may comprise a liquid crystal display (LCD) or other display device. In the context of this disclosure, a non-transitory computer-readable medium stores programs for use by or in connection with an instruction execution system, apparatus, or device. More specific examples of a computer-readable medium may include by way of example and without limitation: a portable computer diskette, a random access memory (RAM), a read-only memory (ROM), an erasable programmable read-only memory (EPROM, EEPROM, or Flash memory), and a portable compact disc read-only memory (CDROM) (optical). With further reference to FIG. 8, network interface device 206 comprises various components used to transmit and/or receive data over a network environment. By way of example, the network interface 206 may include such devices as a modem, a radio frequency (RF) transceiver, a telephonic interface, a bridge, a router, network card, etc. The network interface 206 may also comprise embedded chip technology which provides wireless capabilities such that the caddie 102A-C acts as a mobile Wi-Fi hotspot. It will be appreciated by persons skilled in the art that a number of implementation details may be varied. For example, the caddie 102A-C may be battery operated or wired to a power source. For some installations, the caddies 102A-C may be fixed to tables, counter tops, or may be freestanding. In battery-operated embodiments, re-chargeable battery packs may be used, and the entire units may be configured to be recharged during off-hours of the restaurant.

Similarly, the content server 132 may be embodied in any one of a wide variety of wired and/or wireless computing devices, such as a desktop computer, portable computer, dedicated server computer, multiprocessor computing device, smart phone, personal digital assistant (PDA), digital camera, and so forth. As with the caddie 102, the content server 132 comprises various components (not shown), including but not limited to, a processing device, I/O interfaces, a network interface, a display, memory, and mass storage connected across a data bus.

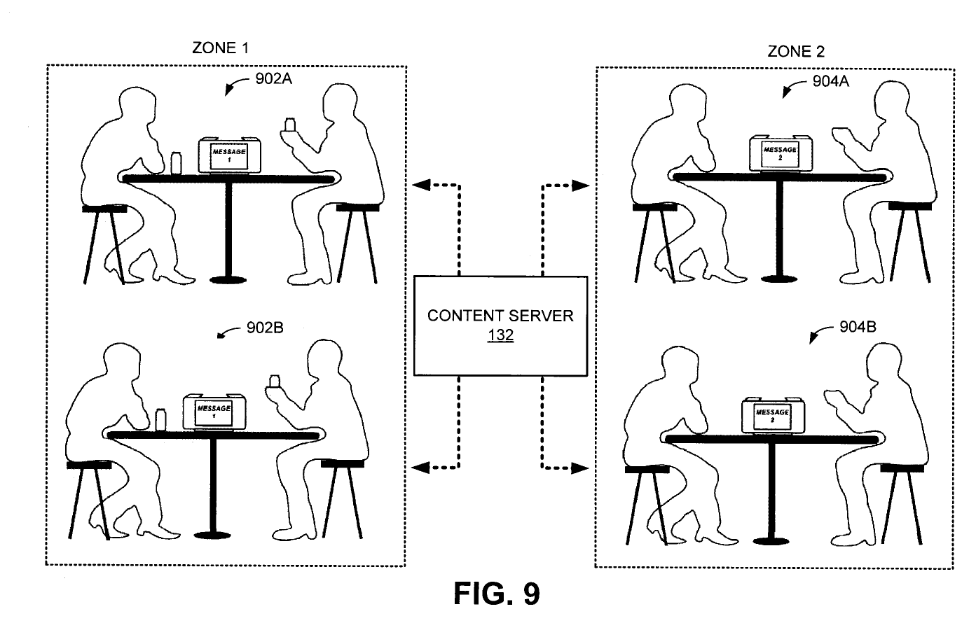

Reference is made to FIG. 9, which illustrates an embodiment of the caddie system whereby the content server 132 is configured to transmit different media content 116 to different caddies 102A-C. In some scenarios, it may be advantageous to send media content 116 that is customized according to the make-up of the customers. To illustrate, suppose that the patrons 902A, B seated in “ZONE 1” in FIG. 9 are all adults. “ZONE 1” may be, for example, the bar area in a restaurant. Suppose also that the patrons 904A, B seated in “ZONE 2” comprise both adults and children. (“ZONE 2” may be, for example, the general dining area where families are seated.) The content server 132 may be configured to convey MESSAGE 1 to the patrons 902A, B in “ZONE 1” and convey MESSAGE 2 to the patrons 904A, B in “ZONE 2.” MESSAGE 1 may comprise, for example, drink specials (e.g., “Draft beer now for only $1.”), while MESSAGE 2 may comprise dinner specials (e.g., “Buy one entrée now and get one free.”). The content server 132 allows the restaurant to customize the content media 116 for different parts/sections of the restaurant.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

At least the following is claimed:

1. A system for conveying information to patrons in an establishment, comprising:
one or more caddies implemented in one or more zones within the establishment, wherein each of the one or more caddies comprises a display unit and one or more compartments for storing items for use by the patrons; and
a content server located in the establishment, the content server configured to transmit information to each of the one or more caddies to be displayed on the display units for the patrons to view, the content server being communicatively coupled to the one or more caddies via a local area network (LAN) implemented within the establishment, wherein the content server transmits information to each of the one or more caddies according to the one or more zones in which the one or more caddies are implemented.

2. The system of claim 1, wherein the information comprises one or more of: advertisements generated by the establishment and advertisements generated by a third party.

3. The system of claim 1, wherein the one or more caddies further comprises an input interface for allowing the patrons to control viewing of the information transmitted by the content server.

4. The system of claim 1, wherein the display unit comprises a liquid crystal display (LCD).

5. A system implemented in an establishment for conveying information to patrons, comprising:
one or more caddies, wherein each of the one or more caddies comprises a display unit; and
a content server configured to transmit media content to each of the one or more caddies to be displayed on the display units, wherein the content server is communicatively coupled to the one or more caddies via a network.

6. The system of claim 5, wherein the network comprises a local area network (LAN), and wherein the one or more caddies and the content server are connected to the network via one or more of: wired and wireless connections.

7. The system of claim 5, wherein the media content transmitted by the content server is generated by a third party.

8. The system of claim 5, wherein the media content comprises advertisements generated by the establishment.

9. The system of claim 5, wherein the media content comprises audio/video content.

10. The system of claim 5, wherein the content server sends media content to the one or more caddies according to zones in which the one or more caddies are located.

11. A caddie, comprising:
a display unit configured to display media content;
a content manager for receiving the media content; and
one or more compartments for storing items.

12. The caddie of claim 11, wherein the content manager further comprises a communication port for communicating with a content server.

13. The caddie of claim 12, wherein the content manager is communicatively coupled to the content server via a network.

14. The caddie of claim 13, wherein the network comprises a local area network (LAN).

15. The caddie of claim 12, wherein the one or more compartments are formed by wall members in the caddie.

16. The caddie of claim 12, wherein the display unit is located in a cavity formed in a body of the caddie.

17. The caddie of claim 16, wherein the compartments are in close proximity to the display unit.

18. The caddie of claim 11, wherein the display unit comprises a flat panel display device.

19. The caddie of claim 18, wherein the flat panel display device comprises a liquid crystal display (LCD).

20. The caddie of claim 11, wherein the media content comprises advertisements.
